(19) United States
(12) Patent Application Publication
(10) Pub. No.: US 2026/0012330 A1
(43) Pub. Date: Jan. 8, 2026

(54) ATTACK AND FAULT TOLERANT IOT NETWORK

(71) Applicant: Commonwealth Scientific and Industrial Research Organisation, Acton, ACT (AU)

(72) Inventors: Dongxi LIU, Acton (AU); Seung JANG, Acton (AU); Bo YAN, Acton (AU)

(21) Appl. No.: 19/134,654

(22) PCT Filed: Nov. 30, 2023
(86) PCT No.: PCT/AU2023/051233

§ 371 Date: May 30, 2025

(30) Foreign Application Priority Data
Dec. 1, 2022 (AU) 2022903653
May 31, 2023 (AU) 2023203403

(51) Int. Cl. H04L 9/08; H04L 9/32

(52) U.S. Cl. CPC H04L 9/0819; H04L 9/321

(57) ABSTRACT

This disclosure relates to an attack and fault tolerant Internet of Things (IoT) network. Multiple handling modules of a computer system subscribe to messages from a publisher device. Each handling module receives a message from the publisher device, processes the message to generate a processed message and signs the processed message using a private key stored on the handling module to generate a signed message. Each handling module then sends the signed message to the other handling modules, subscribes to messages from the other handling modules and receives multiple signed messages from the other handling modules. Each handling module then determines a consensus upon receiving a majority number of the multiple signed messages from the other handling modules, generates a consensus message containing the multiple respective signatures of the handling modules in response to determining the consensus and sends the consensus message to the subscriber device.

### CROSS-REFERENCE TO RELATED APPLICATIONS

The present application claims priority from Australian Provisional Patent Application No 2022903653 filed on 1 Dec. 2022, the contents of which are incorporated herein by reference in their entirety.

### TECHNICAL FIELD

This disclosure relates to an attack and fault tolerant Internet of Things (IoT) network.

### BACKGROUND

Internet of Things (IoT) are being widely deployed in a variety of domains, such as digital manufacturing and Industry 4.0, intelligent agriculture, and smart cities. A typical IoT network usually consists of sensors and actuators, which are deployed in fields and then connected to more powerful computing devices for data storage and analysis for data-driven decision making.

The IoT network can be attacked maliciously in cyberspace or its components could suffer malfunctioning from their own faults. Due to resource-constraint characteristics of IoT devices, high diversity of device types, and large-scale connectivity, it is challenging to ensure security and reliability of an IoT network in a long period of time after the network is deployed, where the network, the operation environments, and the capabilities of attackers keep changing and evolving.

Any discussion of documents, acts, materials, devices, articles or the like which have been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

A method for communicating a message on an Internet of Things (IoT) network comprising multiple handling modules, the method comprising:
performing by each of the multiple handling modules:
   subscribing to messages from a publisher device;
   receiving a message from the publisher device;
   processing the message from the publisher device to generate a processed message;
   signing the processed message using a private key stored on the handling module to generate a signed message;
   sending the signed message to other handling modules of the multiple handling modules;
   subscribing to messages from the other handling modules;
   receiving multiple signed messages from the other handling modules, each of the multiple signed messages comprising multiple respective signatures;
   determining a consensus upon receiving a majority number of the multiple signed messages from the other handling modules with corresponding payloads;
   in response to determining the consensus, generating a consensus message containing the multiple respective signatures of the handling modules; and
   sending the consensus message to a subscriber device,
   wherein receiving and sending messages between the publisher device, the subscriber device and the other handling modules comprises sending and receiving messages to and from multiple message brokers.

It is an advantage to generate a consensus message and send the consensus message to the subscriber device as various modules and IoT devices may be faulty or malicious. In this case, the multiple handling modules are able to reach a consensus by receiving multiple copies of the same signed message. It is a further advantage to leverage the multiple handling modules as these modules can be simply added to the IoT network, without significant modification to the various existing modules or IoT devices.

In some embodiments, receiving and sending messages to and from the multiple message brokers comprises using a messaging protocol, the messaging protocol being one of:
Messaging Queue Telemetry Transport (MQTT) protocol;
Advanced Message Queuing Protocol (AMQP);
Constrained Application Protocol (CoAP); or
Data Distribution Service (DDS).

In some embodiments, processing the message comprises receiving multiple copies of the message from the multiple message brokers and storing each message in a one-dimensional data buffer at a data location within the buffer, wherein the data location is associated with one of the multiple message brokers.

In some embodiments, the method further comprises determining a set of rules, wherein
each message comprises a message topic; and
each rule in the set defines:
   an input topic and an output topic; and
   a processing logic function, wherein applying the processing logic function to an input value associated with the input topic determines an output value associated with the output topic.

In some embodiments, the output topic of a rule in the set is the input topic to another rule in the set.

In some embodiments, performing by each one of the multiple handling modules, processing the message comprises:
determining a rule in the set to apply to the message by associating the message topic of the message with the input topic of one of the rules in the set;
   wherein the input value associated with the input topic corresponds to a payload of the message;
applying the rule to the message by applying the respective processing logic function to the input value to determine the output value associated with the output topic, the processed message thereby comprising the output topic and the output value.

In some embodiments, wherein the set of rules comprises a consensus rule and generating the consensus message comprises processing the message by applying the consensus rule;
wherein the output topic of the consensus rule is different from the input topic of any other rule in the set and the consensus message comprises the output topic of the consensus rule.

In some embodiments, each rule in the set defines a validity check function and processing the message or the signed message comprises validating the message by applying the validity check function to the message.

In some embodiments, if the message topic of the signed message corresponds to the input topic of a rule in the set and the rule is different from the consensus rule, the method further comprises, performing by each one of the multiple handling modules:
processing the signed message by applying the rule to the signed message to generate an output message;
   wherein applying the rule comprises applying the respective processing logic function to a payload of the signed message to determine an output value and the output message comprises the output value and the output topic of the rule.

In some embodiments, performing by each one of the multiple handling modules, signing the processed message or the output message comprises adding a timestamp to the message, the timestamp being indicative of a time that the message is signed by the handling module.

In some embodiments, upon receiving the multiple signed messages from the multiple message brokers, processing the signed message comprises storing each message in a two-dimensional data buffer at a data location within the buffer, wherein
a first dimension is indicative of the multiple message brokers and a second dimension is indicative of the multiple handling modules; and
the data location is associated with one of the multiple message brokers and one of the multiple handling modules.

In some embodiments, upon receiving messages from the multiple message brokers, storing the messages in the one-dimensional or two-dimensional data buffer comprises filling the one-dimensional or two-dimensional data buffer asynchronously by storing each message at the respective data location within the one-dimensional or two-dimensional data buffer.

In some embodiments, determining the consensus among the multiple signed messages comprises determining a consensus across the multiple message brokers and then determining a consensus across the multiple handling modules from the two-dimensional data buffer.

In some embodiments, each of the multiple respective signatures in the consensus message corresponds to the signature of each handling module that participates in the consensus across the multiple handling modules.

In some embodiments, the method further comprises, performing by each one of the multiple handling modules, verifying each signed message received from the other handling modules using the public key of each other handling module and discarding the signed message if the signature does not correspond to the other handling module.

Software that, when installed on a computer and executed by the computer, causes the computer to perform the method of any one of the preceding claims.

A computer system comprising:
a publisher device;
a subscriber device;
multiple message brokers, each configured to subscribe to messages from the publisher device and messages from multiple handling modules; and
publish messages to the multiple handling modules and the subscriber device; and
   multiple handling modules, each configured to:
   subscribe to messages from the publisher device;
   receive a message from the publisher device;
   process the message from the publisher device to generate a processed message;
   sign the processed message using a private key stored on the handling module to generate a signed message;
   send the signed message to the other handling modules;
   subscribe to messages from the other handling modules;
   receive multiple signed messages from other handling modules of the multiple handling modules, each of the multiple signed messages comprising multiple respective signatures;
   determine a consensus upon receiving a majority number of the multiple signed messages from the other handling modules with corresponding payloads;
   generate a consensus message containing the multiple respective signatures of the handling modules in response to determining the consensus; and
   send the consensus message to the subscriber device.

In some embodiments, a total number of message brokers is equal to a total number of handling modules.

In some embodiments, the computer system comprises at least four handling modules.

In some embodiments, each handling module comprises a first memory configured to store each message received from the multiple message brokers in a one-dimensional data buffer at a data location within the buffer, wherein the data location is associated with one of the multiple message brokers.

In some embodiments, each handling module comprises a second memory configured to store each message received from the multiple message brokers in a two-dimensional data buffer at a data location within the buffer, wherein
a first dimension is indicative of the multiple message brokers and a second dimension is indicative of the multiple handling modules; and
the data location is associated with one of the multiple message brokers and one of the multiple handling modules.

In some embodiments, the subscriber device is configured to verify each signature on the consensus message using the public key of each handler module.

Optional features provided in relation to the method, equally apply as optional features to the software and the system.

### BRIEF DESCRIPTION OF DRAWINGS

An example will be described with reference to the following drawings:

FIG. 1 illustrates a system for an attack and fault tolerant Internet of Things (IoT) network.

FIG. 2 illustrates a method for communicating a message on an Internet of Things (IoT) network.

FIG. 3 illustrates the architecture of the disclosed method and system.

FIG. 4 illustrates the architecture of the handling modules.

FIG. 5 illustrates a Buffer Type 1, where four message brokers have been assumed.

FIG. 6 illustrates a Buffer Type 2, where four message brokers and handling modules have been assumed.

FIG. 7 illustrates a Buffer Type 3, where two rules have been assumed.

FIG. 8 illustrates the High-level Message Processing Flow of Interpretation Engine of the handling modules.

FIG. 9 illustrates a Buffer Type 1 for the Smoke topic where messages from the smoke sensor has been received, in the example.

FIG. 10 illustrates a Buffer Type 3 after determining a consensus in the Buffer Type 1, in the example.

FIG. 11 illustrates a filled Buffer Type 2 part 1 on a handling module after receiving multiple signed messages, in the example.

FIG. 12 illustrates a filled Buffer Type 2 part 2 on a handling module after determining a consensus across the message brokers, in the example.

FIG. 13 illustrates this Buffer Type 3 after determining a consensus in the Buffer Type 2 part 1 and after determining a consensus in the Buffer Type 2 part 2, in the example

### DESCRIPTION OF EMBODIMENTS

An Internet of things (IoT) (or IoT network) generally describes physical objects (or groups of such objects) with sensors, processing ability, software and other technologies that connect and exchange data with other devices and systems over the Internet or other communications networks. Devices that are part of the IoT network (which may be referred to as IoT devices) communicate with each other by sending and receiving message to each other on the network. In some IoT networks, a message from one device may need to be distributed to multiple receiving device. Likewise, an IoT device may need to receive a message from multiple devices.

Rather than a point-to-point messaging service, where the sending and receiving device are known to each other and have a one-to-one relationship, some IoT networks utilise a publish-subscribe messaging service, where senders of messages (which may be referred to as publishers or publishing devices), do not program the messages to be sent directly to specific receivers (which may be referred to as subscribers or subscribing devices). Instead published messages are categorised into classes (as referred to as topics) without knowledge of which subscribers, if any, there may be. Similarly, subscribers express interest in one or more classes and only receive messages that are of interest, without knowledge of which publishers, if any, there are. Typically, in a publish-subscribe messaging service, publisher devices publish a message with a message topic, which indicates what the message is about. Different publisher devices may publish different messages with the same topic. The subscriber devices will be subscribe to topics from which they want to receive messages. All messages posted to with a topic are distributed to all applications that have subscribed to it. This is a broadcast-style distribution method in which the message's publisher and subscribers have a one-to-many relationship.

In order for different devices on the IoT network to communicate with each other, message brokers are often utilised. A message broker is an intermediary computer program module that translates a message from the formal messaging protocol of the sending device to the formal messaging protocol of the receiving device. As such, the primary purpose of a message broker is to take incoming messages from applications and perform some action on them. Message brokers are available in both open source and proprietary implementations. For example, message brokers can be implemented in an IoT network via a cloud computing environment, such as services like Amazon Web Services (AWS) Amazon MQ, or open-source message broker software, such as RabbitMQ (https://www.rabbitmq.com/).

Message brokers translate messages from publisher devices to subscriber devices according to a messaging protocol. An example of such a messaging protocol is the Message Queue Telemetry Transport (MQTT) protocol. MQTT is a publish-subscribe messaging protocol that works on top of the Transmission Control Protocol/Internet protocol (TCP/IP). MQTT is a lightweight, publish-subscribe, machine to machine network protocol, designed for connections with remote locations that have devices with resource constraints or limited network bandwidth.

In IoT networks with a publish-subscribe service, it is difficult to build in redundancy if no entity (such as an IoT device or message broker) actually knows that there are redundant entities in the network. For example, if an entity becomes faulty, it does not communicate to other entities that it has stopped working and the other entities would simply continue operating and assume the entity is operating correctly. Redundancy refers to the principle of using backup network resources to minimise or prevent downtime if there is a power outage, hardware malfunction, human error, system failure, or cyber-attack. It often involves running alternative instances of core network services and building duplicate network infrastructure and, as such, can be difficult to implement in an IoT network environment. However, redundancy is important in an IoT network, as it enables continuous communication between IoT devices, when entities are compromised, such as through a cyberattack or a technical fault.

The disclosed method and system uses an architecture comprising multiple message brokers (such as MQTT brokers, for example) and multiple handling modules (as referred to Byzantine Fault Tolerance Application Handlers or “BFT-APP-Handlers”). In this architecture, each component is replicated onto at least four computing nodes (as an example) for supporting attack and fault tolerance of one node. The number of replications is 3+f+1 for tolerating f compromised nodes, where a compromised node may be maliciously attacked or faulty. For example, a system of four computing node can tolerant one compromised node. In another example, a system of seven computing node can tolerant two compromised nodes. There is one group of replicated publish-subscribe services (i.e., the group of message brokers) in this architecture; however, there may be more. Similarly, there may be more replicated groups of other network components, such as more groups of BFT-APP-Handlers, various IoT device and different analyses.

The disclosed method and system enables the IoT network to become attack and fault tolerant and introduces redundancy by determining consensus of multiple copies of a message published by an IoT network component. When enough copies of the message are received, a consensus can be determined, which enables the original message, published by the network component, to be communicated to another network component that is subscribed to these messages. As such, there is no need for a centralised authority to monitor the consensus, as each one of the multiple handling modules determines a consensus independently of the other handling modules. Determining a consensus across the multiple copies of the message enables the IoT network to tolerant compromised nodes (such as a message broker and/or handling module), as messages are still communicated through the network, despite the presence of compromised nodes. For example, if there f compromised nodes, 2*f+1 copies of the message may be necessary to determine a consensus.

The publish/subscribe service is the communication hub of this architecture, as all messages may be exchanged via this publication/subscribe service. The communication protocol at transport layer may be Transmission Control Protocol (TCP), which can keep the orders of messages from the same sources, such as an IoT sensor. The Transmission Control Protocol (TCP) is a transport protocol that is used on top of the Internet Protocol (IP) to ensure reliable transmission of packets. Since TCP is the protocol used most commonly on top of IP, the Internet protocol stack is sometimes referred to as TCP/IP. In this disclosure, the publish/subscribe service may publish messages in the order the messages are received. As such, the messages published by one network component may be received in the same order as they are published.

The techniques of this disclosure are implemented in BFT-APP-Handler (i.e., handling module), which itself is replicated. To apply these techniques, the administrators of an IoT network may simply replicate the network components to tolerate faults and attacks, then connect these network components to a group of BFT-APP-Handlers to make the network components work coherently. As such, this provides an advantage to the administrator as there is no need for the administrator to implement the consensus mechanism, as the consensus mechanism is contained within the BFT-APP-Handlers. For example, an existing IoT network may have one or more message brokers, and the administrators may replicate these message brokers and add the group of BFT-APP-Handlers to the network to perform the method described herein. The BFT-APP-Handlers may only need to be configured to subscribe to messages from the publisher device and receive message from the publisher device via the message brokers, while the message broker may only need to be configured to send and receive messages to and from the multiple handling modules.

A network component may be an IoT device, such as a sensor, receiver, and may publish messages and also receive messages. An IoT network component may not need to be changed from its message publishing functionality when adding the BFT-APP-Handlers to the IoT network. However, the receiving functionality may be changed to be able to check the signatures of BFT-APP-Handlers and manage multiple copies of one message sent from different BFT-APP-Handlers.

The techniques described in this disclosure include algorithms and protocols that enable the replicated components to work coherently together to accomplish fault and attack tolerance. When consensus of a message is achieved among BFT-APP-Handlers, it may be sent to the subscribed receivers with the signatures of all BFT-APP-Handlers. A small number of compromised BFT-APP-Handlers or publish/subscribe services (message brokers) cannot forge a valid number of signatures; thereby, mitigating the risk of Denial of Service (DoS) attacks. The usability feature of the techniques described in this disclosure by BFT-APP-Handlers are summarised below:
BFT-APP-Handlers support the fault and attack tolerance of all network components if they can be replicated by the IoT network administrators;
BFT-APP-Handler are programmable, facilitating complex event processing in a fault and attack tolerance environment and supporting different fault tolerance protocols;
Publishing devices and components on the IoT network may be unchanged, and hence the IoT sensors can be directly deployed in the architecture of this disclosure;
The architecture brings fault tolerance into publish/subscribe communication model;
The architecture is scalable by enabling multiple replication groups of publish/subscribe services and multiple replication groups of BFT-APP-Handlers on low cost devices.

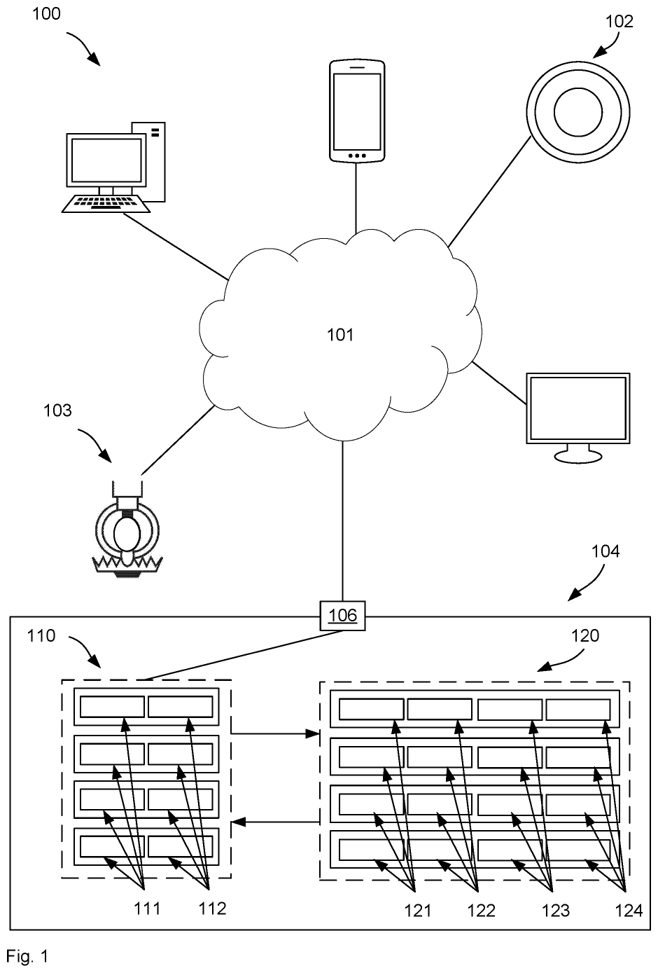

FIG. 1 illustrates a system 100 for an attack and fault tolerant Internet of Things (IoT) network 101. The IoT network 101 may comprise, for example, various devices including computer systems, smart devices, sensors, and video displays. These devices may be interconnected through various forms of communication, such as the Internet or local IP network, for example. In an example, system 100 comprises publisher device 102, which may be a smoke detector and subscriber device 103, which may be a sprinkler, for example. The aim is that the sprinkler turns on in response to the smoke detector detecting smoke.

Publisher device 102 may be configured to publish messages (e.g. {topic: Smoke, payload: 1}) to various devices on IoT network 101. Subscriber device 103 may be configured to subscribe to messages from publisher device 102. Only 6 devices in IoT network 101 are shown in FIG. 1 for illustration purposes. In most practical applications, more devices are connected to IoT network 101. In some examples, IoT devices are resource-constrained devices and as such, may operate without an operating system due to limited resources. This means that compiled source code comprises all required low-level access functions using included libraries, rather than relying on functions provided by the operating system hosting device drivers. For example, IoT devices may only include a system-on-chip microcontroller rather than a microprocessor. The microcontroller may be a ESP32 series microcontroller by Espressif Systems.

The system 100 also comprises a server 104 which itself comprises multiple message brokers 110 and multiple handling modules 120. Multiple message brokers 110 are each configured to subscribe to messages from publisher device 102 and messages from the multiple handling modules 120; and publish messages to the multiple handling modules 120 and subscriber device 103. Each of the multiple message brokers 110 may comprise program memory 111 and data memory 112.

Having multiple message brokers and handling modules introduces redundancy into system 100 as it enables messages from publisher device 102 to continue being communicated to subscriber device 103, even if the multiple message brokers 110 and/or handling modules 120 are compromised, by establishing a consensus. Each of the multiple handling modules 120 determines a consensus by receiving a majority amount of the same message from the multiple message brokers 110 and the multiple handling modules 120.

For example, if there are four message brokers and four handling modules, each message broker may receive a message from publisher device 102 and publish the message to each handling module. Assuming that none of the message brokers are compromised, each handling module receives four copies of the original message and each handling modules establishes a majority. If a message broker is compromised, each handling module may only receive three copies of the original message, however each handling module still receives a majority number of the same message (with four message brokers and handling modules, three messages is a majority. In another example, with seven message brokers and handling modules, five message is a majority). Each handling module then processes the message by applying rules and sends the processed message to each message broker. Each message broker then sends each message received by the handling modules to each handling module.

If none of the message brokers of handling modules are compromised, in this example, each handling module receives sixteen copies of the original message. However, if a message broker is compromised, each handling module may only receive twelve copies of the original message. Likewise, if a handling module is compromised, each of the other handling modules may only receive twelve copies of the message. Each handling module then determines a consensus independently from the other handling modules by determining whether it has received a majority number of messages from each message broker and each handling module. As such, a consensus can be determined even when a message broker and/or handling module is comprised. Each handling module that determines a consensus generates a consensus message and sends the consensus message to subscriber device 103.

Multiple handling modules 120 are each configured to subscribe to messages from publisher device 102, receive a message from publisher device 102, process the message from publisher device 102 to generate a processed message, sign the processed message using a private key stored on the handling module to generate a signed message, send the signed message to the other handling modules, subscribe to messages from the other handling modules, receive multiple signed messages from other handling modules of the multiple handling modules, each of the multiple signed messages comprising multiple respective signatures, determine a consensus among the multiple signed messages received from the other handling modules, generate a consensus message containing the multiple respective signatures of the handling modules in response to determining the consensus, and send the consensus message to subscriber device 103.

Each of the multiple handling modules 120 comprises program memory 121 and data memory 122. Each handling module may further comprise first memory 123 configured to store each message received from the multiple message brokers 110 in a one-dimensional data buffer at a data location within the buffer, wherein the data location is associated with one of the multiple message brokers 110. Each handling module may further comprise second memory 124 configured to store each message received from the multiple message brokers 110 in a two-dimensional data buffer at a data location within the buffer, wherein a first dimension is indicative of the multiple message brokers 110 and a second dimension is indicative of the multiple handling modules 120; and the data location is associated with one of the multiple message brokers 110 and one of the multiple handling modules 120.

Server 104 is part of the IoT network 101 and may be one of many devices on the IoT network 101. Server 104 also comprises an input/output (I/O) port 106. In system 100, server 104 may comprise respective operating systems, such as MS Windows or Linux, and are in communication with each other via the IoT network 101. However, server 104 may communicate with any device that is part of the IoT network. Devices on IoT network 101 may communicate with each other by leveraging an application programming interface (API).

While the multiple message brokers 110 and multiple handling modules 120 are both part of server 104 in FIG. 1, in some examples, they may be on different devices. In one example, the multiple message brokers 110 may be on one server and the multiple handling modules 120 may be on another server. Both servers may be in direct communication with one another or may communicate with one another through the IoT network 101 using a publish/subscribe protocol.

In some examples, the multiple message brokers 110 and the multiple handling modules 120 may be implemented in one or more processors of a computer system. As such, performing the functionality of the multiple message brokers 110 and/or the multiple handling modules 120 may comprise executing program code on the one of more processors. In other examples, each message broker and handling module may comprise one of more processors and executed program code stored on program memory 111, 121 to perform the functionality of the respectively module.

The data memory 112 stores the messages received from publisher device 102 or the multiple handling modules 120. The data memory 112 also stores the public key of each one of the multiple handling modules 120. The data memory 122 stores the messages received from publisher device 102 or the multiple handling modules 120 received from the multiple message brokers 110, as well as the various types of data buffers. More specifically, each message may comprise a payload according to an IoT protocol and a message topic which is stored on the data memory 112, 122. Each component of the IoT network 100 can subscribe to any topic and may then receive all messages that contain that topic.

For example, the IoT protocol may be Messaging Queue Telemetry Transport (MQTT) protocol, Advanced Message Queuing Protocol (AMQP), Constrained Application Protocol (CoAP) or Data Distribution Service (DDS). The message stored on data memory 112, 122 may be a message received from publisher device 102, processed message, signed message or a consensus message. The message may be stored on data memory 112, 122 as JavaScript Object Notation (JSON) file, Packet Capture (PCAP) file or a similar/equivalent format, for example.

The data memory 122 also stores the public key and the private key of the respective handling modules, as well as the public key of the other handling modules. A public key infrastructure (PKI) may be used to bind the public keys with the respective handling module and can be used to make sure the public keys are correct through the use of certificates. For example, the PKI may be the Hypertext Transfer Protocol Secure (HTTPS) protocol or may be based on SSL certificates. The binding of the public keys with their respective handling modules may be established through a process of registration and issuance of certificates at and by a certificate authority (CA), who utilises a root certificate as a the private key to “sign” other certificates. A registration authority (RA) may be delegated by a CA to assure valid and correct registration.

The data memory 122 also stores a set of rules wherein each message comprises a message topic; and each rule in the set defines: an input topic and an output topic; and a processing logic function, wherein applying the processing logic function to an input value associated with the input topic determines an output value associated with the output topic.

Multiple handling modules 120 receives data through all these interfaces, which include memory access of volatile memory, such as cache or RAM, or non-volatile memory, such as an optical disk drive, hard disk drive, storage server or cloud storage. System 100 may further be implemented within a cloud computing environment, such as a managed group of interconnected servers hosting a dynamic number of virtual machines.

It is to be understood that any receiving step may be preceded by the multiple handling modules 120 determining or computing the data that is later received. For example, the multiple handling modules 120 may store the message received from publisher device 102 via the multiple message brokers 110 on data memory 122, such as on RAM or a processor register. Multiple handling modules 120 then requests the data from the data memory 122, such as by providing a read signal together with a memory address. The data memory 122 provides the data as a voltage signal on a physical bit line.

The multiple message brokers 110 and the multiple handling modules 120 may receive data, such as messages from publisher device 102, from data memory 112, 122 as well as from the I/O port 106. In one example, the multiple message brokers 110 and the multiple handling modules 120 receives the messages from publisher device 102 via I/O port 106, such as by using a Wi-Fi network according to IEEE 802.11. The Wi-Fi network may be a decentralised ad-hoc network, such that no dedicated management infrastructure, such as a router, is required or a centralised network with a router or access point managing the network.

Although I/O port 106 is shown as a single entity, it is to be understood that any kind of data port may be used to receive data, such as a network connection, a memory interface, a pin of the chip package of a processor implemented in server 104, or logical ports, such as IP sockets or parameters of functions stored on program memory 121 and executed by the multiple handling modules 120. The parameters of functions may be stored on data memory 122 and may be handled by-value or by-reference, that is, as a pointer, in the source code.

Server 104 may also be configured to or connected to a monitor or display, in which a user of server 104 may interact. Software may provide a user interface presented to the user on server 104. The user interface is configured to accept input (via buttons or text fields etc.) from the user, via a touch screen or a device attached to server 104 such as a keyboard or computer mouse. These devices may also include a touchpad, an externally connected touchscreen, a joystick, a button, and a dial.

In some examples, a total number of message brokers is equal to a total number of handling modules. For example, as shown in FIG. 1, there are four message brokers and handling modules. In some examples, system 100 comprises at least four handling modules. As such, system 100 would also comprise at least four message brokers. With four handling modules and four message brokers, one of the multiple message brokers 110 or the multiple handling modules 120 may be faulty or compromised, as the handling modules can still reach a consensus.

In some examples, subscriber device 103 may be configured to verify each signature on the consensus message using the public key of each handler module. As such, subscriber device 103 may store the public key of each of the multiple handling modules 120. In this example, subscriber device 103 may be configured to discard the consensus message if the signature does not correspond to the signature of one or more handling modules.

FIG. 1 is one example of a configuration of system 100. However, system 100 is not strictly limited to this configuration and this may be one possible embodiment of system 100. In another example, the IoT network 101 may comprise hundreds of devices (only a small number of devices are shown here for simplicity). There may be more than four message brokers and handling modules. In one example, there may be seven message brokers and seven handling modules, for which messages can still be communicated through IoT network 101 if two message brokers and/or two handling modules are compromised. In another example, there may be sixteen message brokers and sixteen handling modules, for which messages can still be communicated through IoT network 101 if five message brokers and/or five handling modules are compromised.

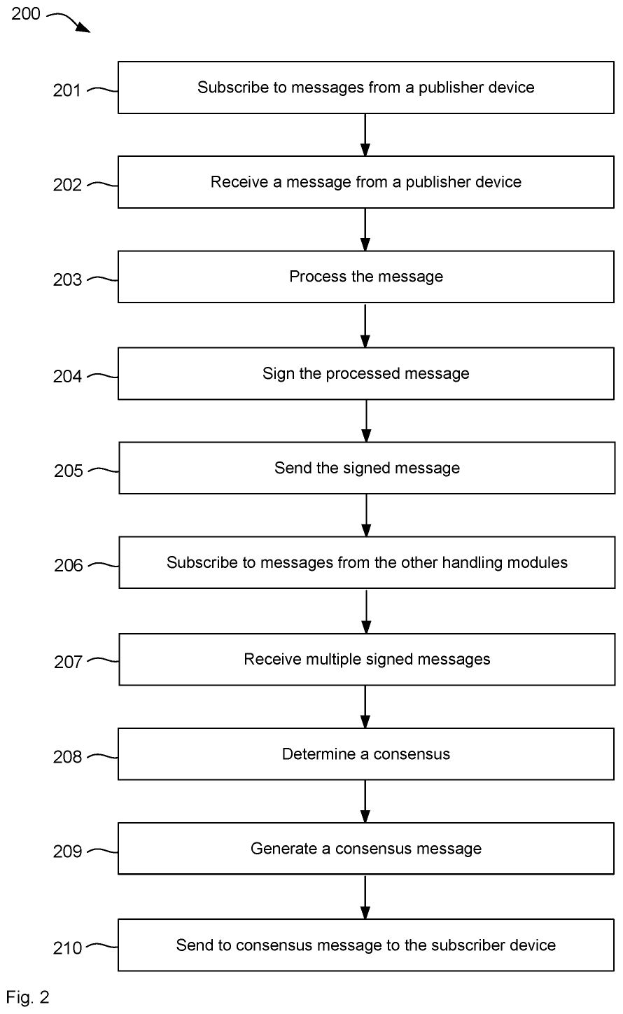

FIG. 2 illustrates a method 200 for communicating a message on an Internet of Things (IoT) network. Method 200 is performed by each of the multiple handling modules 120. Program memory 111, 121 is a non-transitory computer-readable mediums, such as a hard drive, a solid state disk or CD-ROM. Software, that is, an executable program stored on program memory 121 causes each of the multiple handling modules 120 to perform the method in FIG. 2.

FIG. 2 is to be understood as a blueprint for the software program and may be implemented step-by-step, such that each step in FIG. 2 is represented by a function in a programming language, such as C++ or Java. The resulting source code is then compiled and stored as computer-executable instructions on program memory 121 of the multiple handling modules 120.

It is noted that for most humans performing the method 200 manually, that is, without the help of a computer, would be practically impossible. Therefore, the use of the computer is part of the substance of the invention and allows performing the necessary calculations that would otherwise not be possible due to a large amount of data and the large number of calculations that are involved.

The multiple handling modules 120 subscribe 201 to messages from publisher device 102. Subscribing means that if publisher device 102 publishes a message, such as in response to detecting smoke for example, the multiple handling modules 120 may receive 202 the message from publisher device 102. In some examples, the multiple message brokers 110 subscribe to messages from publisher device 102 and publish the messages to the multiple handling modules 120. As such, all communication between publisher device 102 and the multiple handling modules occurs via the multiple message brokers 110. In some examples, subscriber device 103 and/or the multiple message brokers 110 subscribe to message from publisher device 102 by subscribing to a message topic. For example, subscriber device 103 may subscribe to messages from any smoke detectors on IoT network 101 by subscribing to the ‘Smoke’ message topic.

The multiple handling modules 120 then process 203 the message from the publisher device to generate a processed message. Processing 203 the message may comprise receiving multiple copies of the message from the multiple message brokers 110. For example, publisher device 102 may send a copy of the same message to each of the multiple message brokers 110. Each message broker may then send the message to each of the multiple handling modules 120. As such, each handling module may receive a number of copies equal to the number of the multiple message brokers 110. For example, if there are four message brokers and four handling modules, each handling module may receive four copies of the message from publisher device 102 via the four message brokers.

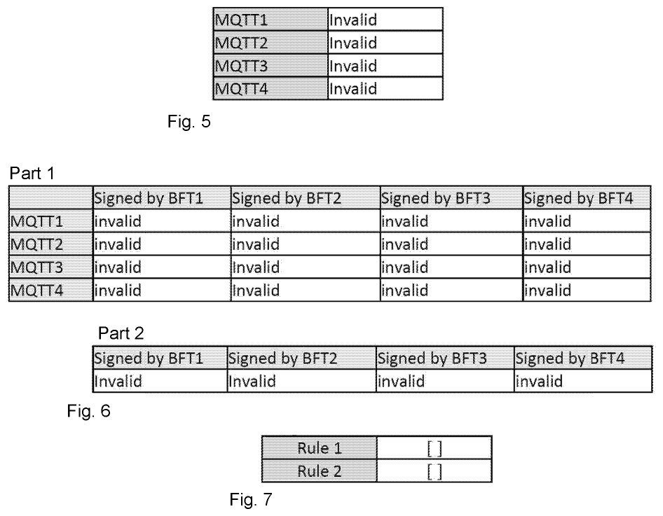

Processing 203 the message may further comprise storing each message in a one-dimensional data buffer at a data location within the buffer, wherein the data location is associated with one of the multiple message brokers 110. An example of this data buffer is shown in FIG. 5. The one-dimensional data buffer may also be referred to as Buffer Type 1. There may be a one-dimensional data buffer for each topic that subscriber device 103 is subscribed. In the example shown in FIG. 5, there are four message brokers. As the multiple copies of the message from publisher device 102 are received by each handling module, the respective handling module may store each message in the data buffer as it is received by the respective handling modules. As such, the data buffer is filled asynchronously. In other words, the data buffer may not store the messages in order of the message broker, but rather the messages may be stored as they are received by the respective message broker. In some examples, each message received by the respective handling module may comprise a payload and a message topic (for example, a message may be {topic: Smoke, payload: 1}) and storing the messages in the data buffer may comprise storing the payload and message topic at a data location within the data buffer. In other examples, only the payload may be stored in the data buffer, as there may be multiple data buffers corresponding to each subscribed topic.

Processing 203 the message may further comprise determining a consensus among the multiple message brokers 110 using the one-dimensional data buffer. Determining a consensus among the multiple message brokers 110 may comprise determining whether there are enough copies of the message from publisher device 102, received from the multiple message brokers 110, to from a consensus. In other words, determining a consensus among the multiple message brokers 110 may comprise determining whether a majority number of the same message are received.

For example, if there are four message brokers in system 100, each handling module may determine whether three or more copies of the message from publisher device 102 have been received by checking the one-dimensional data buffer. If three or more copies of the message are received, then a consensus is reached among the multiple message brokers 110. Upon determining a consensus among the multiple message brokers 110, processing 203 the message may then proceed. In some examples, processing 203 the message may proceed in response to receiving three copies of the message. However, if less than three copies of the message are determined by checking the one-dimensional data buffer, then processing 203 the message may not proceed as a consensus has not been reached. If a consensus is not reached, server 104 may send an alert to one or more devices on IoT network 101. The alert may comprise log data that details information and/or the events that led to a consensus not being reached. For example, the log data may comprise the two-dimensional data buffer from each handling module in a form that is readable by a human user, who may determine from the two-dimensional data buffers that a message broker or handling module has been compromised.

Method 200 may further comprise determining a set of rules, wherein each rule in the set defines: an input topic and an output topic: and a processing logic function. Applying the processing logic function to an input value that is associated with the input topic determines an output value associated with the output topic. In some examples, determining the set of rules may comprise retrieving a pre-determined set of rules in the form of a JavaScript Object Notation (JSON) file. In others examples, determining the set of rules may comprise receiving, on server 104, user input indicative of the rules. As such, a user may define each rule including the input and output topics of each rule and the processing logic function of each rule.

For example, one rule may be defined to apply to messages that contain ‘Smoke’ as a message topic, such as messages that are published by a smoke detector. As such, the rule may define ‘Smoke’ as its input topic and may define an output rule that is the input topic to another rule. In this example, the output topic may be related to a message that is intended to be heard by a sprinkler, such as “Sprinkler Commit”, which may have an associated output message value, such as “on”, as determined by the processing logic function.

In some examples, the output topic of a rule in the set is the input topic to another rule in the set. For example, there may be three rules in the set, where the input topic to rule 1 is different from the output topic of any other rule in the set, the output topic of rule 1 is the input topic to rule 2 and the output topic of rule 2 is the input topic to rule 3. A rule where the input topic is different to the output topic of all other rules in the set may be referred to as an input rule. In this example, rule 1 may be considered an input rule and each set of rules may only comprise one input rule. In some examples, there may be a rule where the output topic is different from the input topic of any other rule in the set.

Processing 203 the message, by each one of the multiple handling modules, may further comprise determining a rule in the set to apply to the message by associating the message topic of the message with the input topic of one of the rules in the set. The input value that is associated with the input topic corresponds to a payload of the message. Processing 203 the message then comprises applying the rule to the message by applying the respective processing logic function to the input value to determine the output value associated with the output topic. As such, the processed message comprises the output topic and the output value. The multiple handling modules 120 then sign 204 the processed message using a private key stored on the handling module to generate a signed message. As such, the signed message may comprise the output topic and the output value of the processed message, as well as the signature of the handling module that processes the message. The private key may be cryptography linked to a public key that may be distributed to each of the multiple handling modules 120 and subscriber device 103. The key pair may be based on an asymmetric key techniques, such as, but not limited to, Diffie-Hellman key exchange protocol, Elliptic-curve cryptography or Rivest-Shamir-Adleman (RSA) encryption algorithm, for example.

In some examples, processing 203 the message, by each one of the multiple handling modules, may further comprise determining a rule in the set to apply to the message by associating the message value of the message with the input value of one of the rules in the set. The message value may be the payload of the message. For example, in the message is {topic: Smoke, payload: 1}, then the message value would be 1.

Each of the multiple handling modules 120 then send 205 the signed message to other handling modules of the multiple handling modules. In some examples, the multiple handling modules 120 may then send 205 the signed message to other handling modules by sending 205 the signed message to the multiple message brokers 110. In some examples, each of the multiple message brokers 110 may receive a signed message from each one of the multiple handling modules 120.

Each of the multiple handling modules 120 then subscribe 206 to messages from the other handling modules and receives 207 multiple signed messages from the other handling modules, each of the multiple signed messages comprising multiple respective signatures. Each handling module may receive multiple copies of a signed message from the multiple message brokers 110. For example, if there are four handling modules and four message brokers, after receiving a signed message from each handling module, each message broker may contain four signed messages, where each signed message would have a different signature. Each of the four message brokers may then send their set of four signed messages to each of the four handling modules. As such, each of the four handling modules may contain sixteen signed messages, corresponding to four copies of each of the four signed messages. It is noted that if all message broker and handling modules are working correctly, then each handling modules should receive sixteen messages, each with the same topic and payload (message value). The signatures on each message may be different, however each handling module should receive four copies of the message with the same signature.

Upon receiving the multiple signed messages from the multiple message brokers 110, method 200 may further comprise storing each message in a two-dimensional data buffer at a data location within the buffer, wherein a first dimension is indicative of the multiple message brokers and a second dimension is indicative of the multiple handling modules: and the data location is associated with one of the multiple message brokers and one of the multiple handling modules. Storing the messages in the two-dimensional data buffer may comprise filling the two-dimensional data buffer asynchronously by storing each message at the respective data location within the two-dimensional data buffer.

An example of a two-dimensional data buffer is shown in FIG. 6, where the rows of the data buffer correspond to the message brokers and the columns correspond to the handling modules. In this example, there are four message brokers and four handling modules. The two-dimensional data buffer may be referred to as a Buffer Type 2, Part 1.

The multiple handling modules 120 may process the signed message by determining a single signed message after receiving multiple signed messages from the multiple message brokers 110. The multiple handling modules 120 may determine the single signed message by determining the consensus among the multiple signed messages, which may comprises determining a consensus across the multiple message brokers 110 and then determining a consensus across the multiple handling modules 120 from the two-dimensional data buffer. For example, if there are four handling modules and four message brokers, the two-dimensional data buffer would resemble a 4×4 table (or matrix). Determining a consensus across the multiple message brokers 110 may comprise checking each row of the data buffer and determining whether there are three or more signed message in each row. Determining a consensus across the multiple handling modules 120 after determining a consensus across the multiple message brokers 110 may comprise checking whether three or more rows of the data buffer have reached a consensus. However, if a handling module does not determine a consensus, then the correspond handling module may send an alert or an error message, which contains log data or information relating to why a consensus was not reached.

If a consensus is determined across the multiple message brokers 110 and then if a consensus is determined across the multiple handling modules 120, the single signed message may be generated which comprises the message topic, message value (such as the payload of the message, for example) of the signed message involved in consensuses (each of the multiple signed messages received by a handling module should have the same message topic and message value, but different signatures). The multiple handling modules 120 may then process the single signed message based on the set of rules.

For example, if the message topic of the signed message corresponds to the input topic of a rule in the set, method 200 may further comprise, performing by each one of the multiple handling modules: processing the signed message by applying the rule to the signed message to generate an output message. Applying the rule may comprise applying the respective processing logic function to a payload of the signed message to determine an output value. Further, the output message may comprise the output value and the output topic of the rule. For example, an output message may be {topic: BFT-Sprinkler-Commit, payload: “on”}, after applying a rule that determines whether a sprinkler should be turned on or off in response to a smoke message. Method 200 may further comprise signing the output message using a private key stored on the handling module to generate a signed output message (the signed output message may be considered a signed message). Method 200 may further comprise sending the signed output message to other handling modules of the multiple handling modules 120.

It is noted that the process of receiving multiple signed messages, determining a single signed message, generating an output message, signing the output message and sending the signed output message may be repeated depending on the set of rules. In particular, this process may occur for each rule, where the input topic is the output topic of another rule and the output topic is the input topic of another rule. These rules may be referred to as intermediate rules. In some examples, a set of rules may not comprise any intermediate rules, for which this process may not be performed.

In some examples, each rule in the set may define a validity check function and processing the message or the signed message comprises validating the message by applying the validity check function to the message. In one example, the validity check function may simply be to check that the message contains a payload, such as payload !=null. In some examples, signing the processed message or the output message comprises adding a timestamp to the message, the timestamp being indicative of a time that the message is signed by the handling module.

The multiple handling modules 120 then determine 208 a consensus among the multiple signed messages received from the other handling modules. In some examples, the multiple handling modules 120 determine 208 a consensus among the multiple signed messages received from the other handling modules by determining a consensus across the multiple message brokers and then determining a consensus across the multiple handling modules from the two-dimensional data buffer. As such, determining 208 the consensus may comprise determining a single signed message as described above and applying the consensus rule to the single signed message.

Upon determining 208 a consensus among the multiple signed messages, the multiple handling modules 120 generate 209 a consensus message containing the multiple respective signatures of the handling modules. The consensus message may comprise the output topic of the consensus rule, as well as the associated output value determined by applying the processing logic function of the consensus rule to the payload (the input value) of the single signed message. In some examples, each of the multiple respective signatures in the consensus message corresponds to the signature of each handling module that participates in the consensus across the multiple handling modules. For example, a consensus message may be {topic: Sprinkler-BFT-consensus, payload: “on”, sig-ts: {(sig1, ts1, 1), (sig3,ts3, 3), (sig4, ts4, 4)}}, which indicates to subscriber device 103 that a consensus has been reached. In this example, the consensus message only contains three handling module signatures as the second handling module may have been compromised. However, a consensus could still been reached on the remaining handling modules.

In some examples, the set of rules may comprise a consensus rule and generating the consensus message comprises processing the message by applying the consensus rule. The output topic of the consensus rule is different from the input topic of any other rule in the set. Further, the consensus message comprises the output topic of the consensus rule. In some examples, the set of rules may only comprise one consensus rule.

The multiple handling modules 120 then send 210 the consensus message to subscriber device 103. As such, subscriber device 103 may receive a consensus message from each one of the multiple handling modules 120. Subscriber device 103 may verify each signature on the consensus message using the public key of each handler module. As such, subscriber device 103 may discard any consensus message that contains signatures that do not correspond to the handling modules. Subscriber device 103 may determine a consensus across the consensus messages received from the multiple handling devices 120. For example, if there are four handling modules, then subscriber device 103 determines a consensus across the multiple handling modules 120 is subscriber device 103 receives three or more consensus messages containing the same payload.

It is noted that while the publisher device 102 and the subscriber device 103 may be low power and low bandwidth devices, bottleneck issues do not present themselves in the disclosed method and system. Communication among the multiple handling modules 120 can be over networks such as WIFI or Ethernet, for example. As such, there is no bandwidth issue when using these networks. Further, when the multiple handling modules communicate through the multiple message brokers 110, publisher device 102 and subscriber device 103 only communicate through the multiple message brokers 110 rather than directly communicating with the multiple handing modules 120. As such, the subscriber device 103 only receives multiple copies of a message from the message brokers 110 if the message needs to be attack and fault tolerant, and this is generated by rules deployed on handling modules. The rules discussed herein can be configured by users to protect a few critical messages if the subscriber device 103 is resource-constrained. Therefore, this mitigates any potential bottleneck issue.

In some examples, method 200 further comprises, performing by each one of the multiple handling modules, verifying each signed message received from the other handling modules using the public key of each other handling module and discarding the signed message if the signature does not correspond to the other handling module.

### Design of BFT-APP-Handlers

The multiple handling modules 120 are synonymously referred to as BFT-APP-Handlers. These are programmable, and based on the configurations and programs defined by users for their applications. As such, BFT-APP-Handlers process messages from the publish/subscribe services and then publish back the results. In other words, a user may program the BFT-APP-Handlers by defining a set of rules. Note that depending on users' programs, the results might be broadcast from one BFT-APP-Handler to other BFT-APP-Handlers for further processing (e.g., to achieve consensus). For example, if there are two rules in the set, the BFT-APP-Handlers may process the message received from publisher device 102 by applying rule 1 to the message. The BFT-APP-Handlers may then each signed the processed message and send to the signed message to the other BFT-APP-Handlers. Rule 2 in this set would correspond to the consensus rule, and rather than further processing the multiple signed messages, a consensus is determined by applying the consensus rule.

FIG. 4 illustrates the architecture of the handling modules. More specifically, FIG. 4 illustrates the high-level architecture of these modules. The configurations (such as the set of rules) may loaded into BFT-APP-Handler via its Management component, which also installs or uninstalls programs. BFT-APP-Handler may have an interpretation engine to process the installed programs. Note that all BFT-APP Handlers may take, as input, the same configurations and programs. In other words, the same set of rules may be stored on each BFT-APP-Handler. In some examples, the interpretation engine of each BFT-APP-Handler may process messages from publisher device 102 and the other BFT-APP-Handlers. In some examples, each BFT-APP-Handler may an interpretation engine for each message broker. As such, FIG. 4 corresponds to an example where there are four message brokers.

### Configurations and Programs

Each BFT-APP-Handler may have two types of configurations: general, and connectivity of network components. The programs in BFT-APP-Handler may be named as Topic Translation that regulates the operations of BFT-APP-Handlers. Topic Translation is discussed later in this disclosure.

### General Configuration

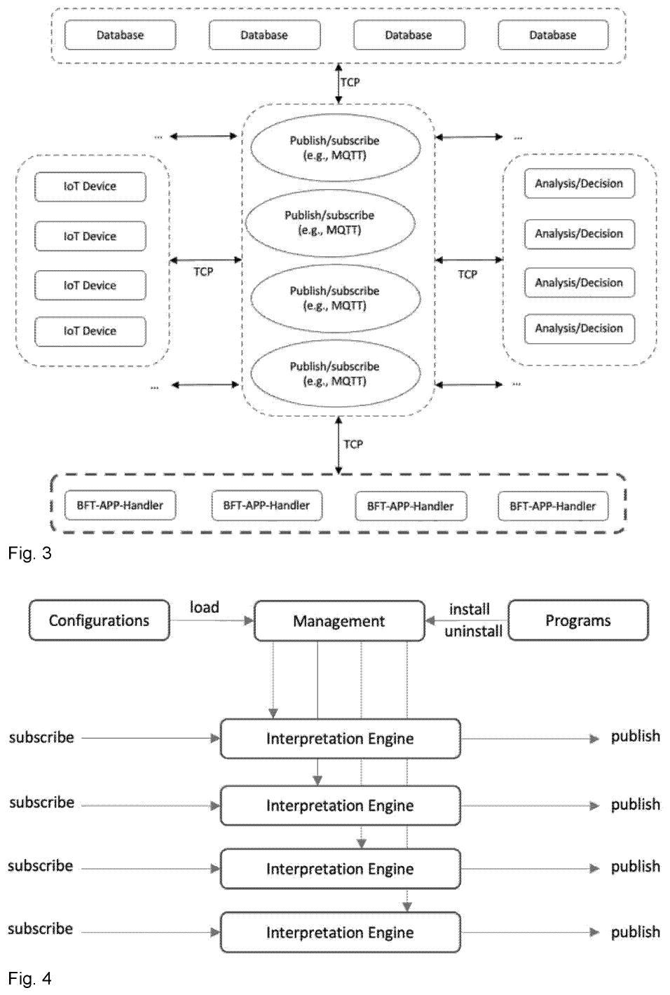

In this disclosure, MQTT brokers are used as an example to represent publish-subscribe services (i.e., the multiple message brokers 110). However, it is noted that other publish-subscribe or IoT protocols may be used by the multiple message brokers 110. The general configuration of the message brokers 110 may include the following elements:
The public key of each BFT-APP-Handler: the public key is used to verify the digital signatures of messages signed by a BFT-APP-Handler; the verification ensures the integrity and authenticity of messages. Each BFT-APP-Handler should have the corresponding private key, which is kept secret. As such, the private key of each BFT-APP-Handler is stored in data memory 122 of the respective BFT-APP-Handler and is not accessible by any other BFT-APP-Handler or message brokers.
IP addresses of MQTT brokers and extra information for connection: this information may enable BFT-APP-Handler to communicate correctly with MQTT brokers. The IP addresses of the MQTT brokers may be stored in data memory 122.
The number of compromised or faulty nodes (in a replicated group) that can be tolerated, denoted by f. For a system with 3+f+1 nodes (such as the multiple message brokers 110 and the multiple handling modules 120), f number of these node may be compromised or faulty. As an example and as shown in FIG. 3, a replicated group includes four nodes of the same type component, and the number f in this example is 1, meaning that one node (e.g., MQTT broker, or BFT-APP-Handler) may be attacked or faulty. The nodes from different groups can be independently attacked or compromised. For example, a MQTT broker node and a BFT-APP-Node may be attacked or faulty at the same time. As such, if there are f compromised nodes, then 2+f+1 uncompromised nodes may be used to determine a consensus. 2+f+1 may be used as a consensus threshold throughout this disclosure. For example, if there is one compromised node, then three uncompromised modes may be used to determine a consensus. As such, three may be considered as the consensus threshold. In another example, if there are two compromised nodes, then five uncompromised modes may be used to determine a consensus. As such, five may be considered as the consensus threshold.
The default time-out value for buffers in BFT-APP-Handlers.

### Connectivity of Network Components

A network component (e.g., a sensor such as publisher device 102) may connect with a group of replicated MQTT brokers in two ways. In the first way, a sensor connects to all MQTT brokers. Messages are thus published to all MQTT brokers. This way of connectivity enables the client to be able to publish one message to all message brokers. Hence, the message may not be blocked if one MQTT broker does not function well. The implementation of sensors might need to be changed for this connectivity. In the second way, a sensor or a network component connects only to one MQTT broker and its implementation does not change if it already supports publish/subscribe communication model.

The configuration for the connectivity of one network component includes:
Topic: specifying the topic of messages published by a network component, such as “room/temperature”;
Connection: “single” or “full”.

### Topic Translation—the Syntax of BFT-APP-Handler Programs

Topic Translation declares a set of rules, each of which indicates how to process messages of one or more topics received from MQTT brokers and generate messages of new topics to publish. Rules are independently declared; however, rules can be semantically linked by enabling the output messages of one rule to be the input messages of other rules. It is noted that the message received from publisher device 102 may not be the same as the message that is published to and received by subscriber device 103. This is because the rules may contain complex processing logic that may modify the content of the message.

To support complex processing logic, the rules may call existing programs in a library for modular software development. As such, user may create complex rules and use existing software libraries to create these rules. Users may prepare their own Topic Translation rules to implement their in-network IoT message processing in an attack and fault tolerant way. Topic Translation rules may be installed into BFT-APP-Handler via the Management component in FIG. 4. It is noted that each message, from publisher device 102 or the multiple handling modules 120, comprises a message topic. For example, if publisher device was a smoke detector, then the messages published by publisher device 102 may comprise the message topic ‘Smoke’. These message may also have an associated message value that is related to the message topic. In some examples, the message topic may be the payload of the message published by publisher device 102. In the example where publisher device 102 is a smoke detector, the message value may be indicative of detection of smoke. For example, the message value may by ‘0’ to indicate no smoke was detected and ‘1’ to indicate that smoke was detected. In some examples, the message value may not be a numerical value, but rather, the message value may be a symbolic value. For example, a message may be {topic: Smoke, payload: “yes”} and hence, the message value (corresponding to the payload) would be symbolic. As such, the processing logic function would be defined to process symbolic values, rather than numerical values.

The abstract syntax of a Topic Translation rule is defined below, consisting of four components:
Input Topics: a list of topics together with the corresponding symbolic values and a timeout value, such as [(topic1, v1, 10 mins), (topic2, v2, 2 mins), . . . ]. In this example, the symbolic values v1 and v2 represent the payloads of messages of the corresponding topics, i.e., topic1 or topic2. After the timeout value (10 mins or 2 mins), the payload of messages represented by v1 and v2 become invalid if they have not been consumed by Processing Logic defined below.
Output Topics: a list of topics together with the corresponding symbolic values, such as [(topic3, o1), (topic4, o2), . . . ]. An output topic may have the post fix or include the string “BFT”, which indicates that a message with this topic is of BFT-APP-Handler origin. In other words, a topic containing a “BFT” string may indicate that the message was processed by a BFT-APP-Handler. Symbolic values o1 and o2 are associated with corresponding output topics, helping link output topics and their payload values returned from Process Logic. The name space of symbolic values (e.g., v1, v2, o1, o2) may be limited to each rule.
Input Validity Check (as referred to as a validity check function): the check is specified as a function call. The function is either defined by the user or from BFT-APP-Handler library. It decides whether symbolic values from Input Topics are valid and hence can be used to execute the Processing Logic defined in the same rule. For example, one application may need both v1 and v2 to have valid values, while another may use at least one of them to be valid. In some examples, as a result of applying a rule from the set of rules to a message, the validity check function may be applied to the input value (i.e., the payload of the message) before applying the processing logic function to the input value to determine an output value.
Processing logic (as referred to as a processing logic function): The Processing Logic is specified as a function call and the function is defined by users to process values represented by symbolic values in Input Topics and return the values of Output Topics if the input Validity Check in the same rule can pass. The input of Processing Logic includes symbolic values (e.g., v1 and v2) declared in Input Topics, and their output is a list of pairs, such as [(o1, 35.1), (o2, “good”)]. The first element of a pair should be declared in the Output Topics, while the second is a value determined by the function. For each pair in the output list, BFT-APP-Handler publishes a message, whose topic is selected from Output Topics based on the first element in the pair (e.g., o1 or o2) and whose value is just the second element of the pair. With this example, a published message has topic3 as topic and 35.1 as its payload, and another published message has topic4 as the topic and “good” as its payload.

### An Example of Topic Translation Rules

The following example is a set of Topic Translation rules for an application, where the values of a temperature sensor and a smoke sensor are used to determine whether a sprinkler should be tuned on or off. In this example, the application may tolerate attacks or faults to MQTT brokers and BFT-APP Handlers. In this example, default timeout values are used, so they do not appear in Input Topics rules below.

TABLE 1
Example of Topic Translation rules

| Input Topics | Output Topics | Validity Check | Processing Logic |
|---|---|---|---|
| [(Smoke, s), | [(Sprinkler-BFT- | check(s, t) | decision(s, t) |
| (Temp, t)] | Commit, a)] | | |
| [(Sprinkler-BFT- | [(Sprinkler-BFT- | true() | id(a) |
| Commit, a)] | consensus, ins)] | | |

In the above example, there are two rules, where rule 1 may be considered an input rule (the input topic is different to the output topic of all other rules) and rule 2 may be considered as the consensus rule (the output topic is different to the input topic of all other rules). In this example, the BFT-APP-Handlers may receive a message from two publisher devices (such as a smoke detector and a temperature sensor) and process these messages by applying rule 1.

Examples of the processing logic and validly check functions used in this example above are defined below:

```
def check(s, t):
  if s != null or t!=null:
    return true
  else:
    return false
def decision(s, t):
  if s == 1 or t > 50:
    return (a,“on”)
  else:
    return (a,“off”)
def true( ):
  return true
def id(a):
  return (ins, a)
```

In this example, a BFT-APP-Handler may receive a message from the smoke detector such as {topic: Smoke, payload: 1}, where ‘Smoke’ is the message topic and ‘1’ is the associate message value. The BFT-APP-Handler may process this message by determining a rule in the set to apply to the message by associating the message topic of the message with the input topic of one of the rules in the set. As such, the BFT-APP-Handler may determine rule 1 as the message topic is ‘Smoke’ and may apply rule 1 to the message by applying the processing logic function (i.e., decision(s,t)) to the input value (i.e., s=1) to determine the output value associated with the output topic. In this example, as s=1, applying the rule by applying the processing logic function would return the output topic “Sprinkler-BFT-Commit” and the output value a=“on”. As such, the processed message may be {topic: Sprinkler-BFT-Commit, payload: “on”}. In another example, the BFT-APP-Handler may also receive a message from the temperature sensor such as {topic: Temp, payload: 25} and may process the messages from the smoke detector and temperature sensor by applying a rule from the set of rules.

In this example, the functions are presented as Python code. However, these functions can be in any languages in different implementations. The function may also call functions and subroutines of an external software library.

### Interpretation Engine With Attack and Fault Tolerance Awareness

The programs represented by Topic Translation may be executed with the Interpretation Engine in BFT-APP-Handler. The Interpretation Engine consists of two algorithms: initialization algorithm and runtime message-processing algorithm.

### Initialization Algorithm

The initialization algorithm on each BFT-APP-Handler reads into configurations and programs, and it finishes initialization with the following steps:
Connects to each MQTT broker based on IP addresses in the configuration:
Go through each rule in Topic Translation (i.e., the set of rules), and subscribe to each input topic in this rule on each MQTT broker. In other words, if each BFT-APP-Handler subscribes 201 to message from a publisher device, the BFT-APP-Handler subscribes to the input topics of the rules. As such, if a BFT-APP-Handler receives a message that contains a message topic that is not an input topic of any rule in the set, the BFT-APP-Handler may simply ignore the message. In this case, this message may not be processed by the BFT-APP-Handler.
Create three types of data buffers as described below. The buffers are independently created by each BFT-APP-Handler. These buffer may be used to store the messages for later use, such as determining a consensus. Each type of data buffer is described in the following paragraphs:

Buffer Type 1: One buffer of this type is created for each input topic in Topic Translation rules. For example, in the example rules of Table 1, each BFT-APP-Handler may create a Buffer Type 1 corresponding to ‘Smoke’ and a separate Buffer Type 1 for ‘Temp’. As such, messages received from the smoke detector may be stored in the data buffer corresponding to the ‘Smoke’ topic, while messages received from the temperature sensor may be store in the data buffer corresponding to the ‘Temp’ topic. It is noted that a topic may appear in multiple Topic Translation rules and still one buffer of this type is created for this topic. This type of buffer may manage messages originated from network components other than BFT-APP-Handlers, such as sensors, publisher devices or machines issuing instructions.

Suppose there are 3*f+1 MQTT brokers. Then, the Buffer Type 1 may be a tuple of 3*f+1 entries, each of which is used to store the messages of this topic from one MQTT broker. In other words, the Buffer Type 1 may be a one-dimensional data buffer, wherein each data location is associated with one of the multiple message brokers 110.

FIG. 5 illustrates a Buffer Type 1, where four message brokers have been assumed. In other words, FIG. 5 illustrates a buffer example by assuming four MQTT brokers are deployed. Initially, all entries are marked as invalid. However, as messages are received by the BFT-APP-Handler from a publisher device via the message brokers 110, the entries may be filled according to the message broker from which the message is received from. For example, if the BFT-APP-Handler receives a message from publisher device 102 from the third message broker (MQTT3, in this example), then the BFT-APP-Handler may store the message (such as the message topic and the message value) in the third entry in the data buffer of FIG. 5. It is noted that this data buffer may be filled asynchronously, as the data buffer may be filled according to when messages are received by the BFT-APP-Handler, rather than filling the buffer in order of its entries.

Buffer Type 2: The messages managed by this type of buffer are originally generated by BFT-APP-Handlers, e.g., messages that have been processed and signed by a BFT-APP-Handler.

The following definitions facilitates the explanation of the management of Buffer Type 2 and Buffer Type 3:
Definition 1 (BFT-APP-Handler Origin Topics): A topic is said to have its origin from a BFT-APP-Handler if this topic appears both in Input Topic and Output Topic in Topic Translation rules. For example, in the rules presented in Table 1, the topic “Sprinkler-BFT-Commit” can be considered to be a BFT-APP-Handler Origin Topic.
Definition 2 (Messages originally generated from BFT-APP-Handler): A message is originally generated by BFT-APP-Handler if its topic is BFT-APP-Handler origin topic. For example, a message that has been processed, signed and received from a BFT-APP-Handler (e.g., a signed message) can be considered as a message originally generated from BFT-APP-Handler.
Definition 3 (Consensus Message): A message is a consensus message if its topic is in Output Topic rules, but not in any Input Topic rules. For example, a consensus message may be generated by applying the consensus rule from the set of rules. This message contains signatures from at least 2*f+1 BFT-APP-Handlers.

Each topic with BFT-APP-Handler origin has its own Buffer Type 2. The buffer of this type consists of two parts. The first part (part 1) is represented as a matrix, which has each entry indexed by a BFT-APP-Handler and a MQTT broker. The second part (part 2) is a tuple, with each entry corresponding to a BFT-APP-Handler. As such, Buffer Type 2 part 1 may be a two-dimensional data buffer, wherein a first dimension is indicative of the multiple message brokers 110 and a second dimension is indicative of the multiple handling modules 120; and each data location within buffer is associated with one of the multiple message brokers 110 and one of the multiple handling modules 120. Further, Buffer Type 2 part 2 may be a one-dimensional data buffer, wherein each data location in the data buffer may be associated with one of the multiple handling modules 120.FIG. 6 illustrates a Buffer Type 2, where four message brokers and handling modules have been assumed. In other words, FIG. 6 illustrates a Buffer Type 2 where four MQTT Brokers and four BFT-APP-Handler have been assumed.

Buffer Type 3: Each Topic Translation rule has a buffer of this type, which is a list. For example, in the rules presented in Table 1, each BFT-APP-Handler may create two Buffer Type 3's corresponding to each rule in Table 1. In another example, there may be one Buffer Type 3 for each set of Topic Translation rules, where each row of the Buffer Type 3 corresponds to one of the Topic Translation rules. Initially, the list is empty. When it is not empty, an element of this list is a tuple, each element in this tuple containing a message corresponding to a topic in Input Topic of this rule. The tuple may be partially filled in the sense that some input topics have received their messages, while others have not. FIG. 7 illustrates a Buffer Type 3 where two rules have been assumed.

### Runtime Message-Processing Algorithm

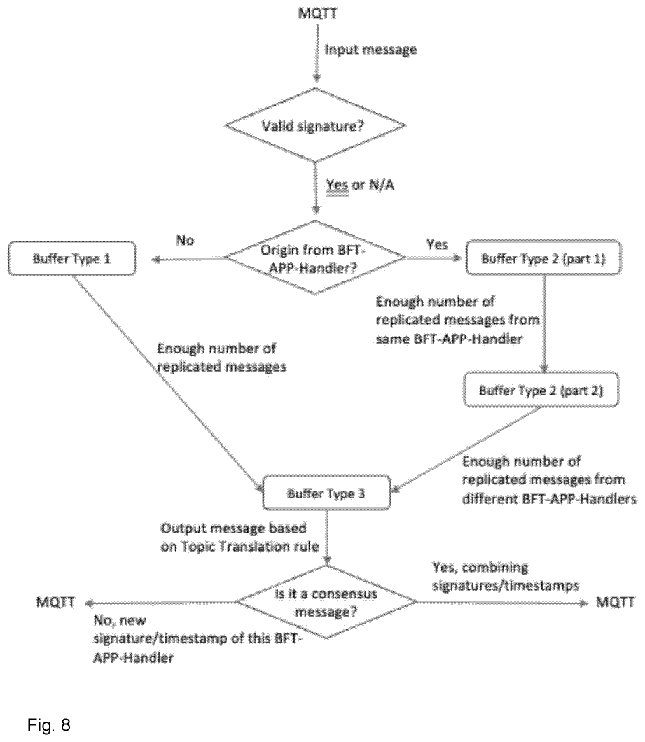

FIG. 8 illustrates the High-level Message Processing Flow of Interpretation Engine of the handling modules. When a new message is received by a BFT-APP-Handler, it is processed in the following steps, which are also illustrated in FIG. 8. It is noted that each BFT-APP-Handler may receive multiple messages from various sensors or publisher devices and multiple message brokers. Each of the multiple messages are processed according to the flow diagram in FIG. 8. The processing may lead to the publish of new messages of output topics:

Signature verification: If a message is originally generated from a BFT-APP-Handler, the BFT-APP-Handler that receives the message verifies the signature of this message with the public key of corresponding BFT-APP-Handler, which can be indicated in the message payload. Messages from BFT-APP-Handlers with wrong signatures may be discarded.

Update buffers of Type 1 and Type 2 with this message following the two cases below if they are applicable:

Case 1: the message is originated from a sensor, publisher device or other network components other than BFT-APP-Handler.
Locate the Buffer Type 1 corresponding to the topic of this message. Recall that each Input Topic defined by the set of rules may have an associated Buffer Type 1 (one-dimensional data buffer);
Locate the entry of this buffer according to the MQTT broker that sends this message. Recall that a Buffer Type 1 uses MQTT broker to index its entries, as illustrated in FIG. 5;
Overwrite this entry of this buffer with this message; and
Handling the buffer further if one of the following conditions is satisfied.
   If the topic of this message is configured as full connection, and at least 2*f+1 entries in this buffer contain the same message, then all entries in this buffer are reinitialized and marked as invalid, and the message is moved to Buffer Type 3. As such, the BFT-APP-Handler determines a consensus across the multiple message brokers 110 using Buffer Type 1 (the number 2*f+1 corresponds to the consensus threshold).
   If the topic of this message is configured as single connection, then move the message to Buffer Type 3, and all entries in this are marked as invalid.

Case 2: the message is originally generated by BFT-APP-Handlers:
Locate the Buffer Type 2 corresponding to the topic of this message. Recall that each topic with BFT-APP-Handler origin (the topic is an input topic of one rule and an output topic of a different rule) has its own Buffer Type 2.
Locate the entry in the first part of this buffer, which is indexed by the MQTT broker that publishes this message and the BFT-APP-Hander that signs this message.
Overwrite this entry of this buffer with this message.
Handling buffer further following the two steps below.
   If a column of this buffer (as illustrated in FIG. 6, a column contains the values originated from the same BFT-APP-Handler, but published via different MQTT brokers) contains at least 2*f+1 entries with the same message, then all entries in this column is marked as invalid, and move the message to the second part in the entry corresponding to the same BFT-APP-Handler. As such, BFT-APP-Handler determines a consensus across the multiple message brokers.
   If the second part of the buffer contains at least 2*f+1 entries with the same message value from different BFT-APP-Handlers, then all entries in the second part of this buffer are marked as invalid, and then combine signatures and corresponding timestamps of different BFT-APP-Handlers with this message value and move them to Buffer Type 3. As such, after determining a consensus across the multiple message brokers, BFT-APP-Handler determines a consensus across the multiple handling modules.

Processing a message received by a BFT-APP-Handler finishes by updating and processing Buffer Type 3.

It is noted that a topic may appear in multiple Topic Translation rules. As such, as a result of updating Buffer Type 3 with a message, this message may be copied for each rule that contains the topic of this message in its Input Topic. Recall that each rule in the set of rules has a list in the buffer of this type. The steps of updating Buffer Type 3 are described below:
Go through each rule in Topic Translation.
If this rule contains a topic of this message as Input Topic, then update the corresponding list with steps below; otherwise, go to the next rule.
   Scan the list and for each tuple in the list, then:
      Locate the entry corresponding to the topic of this message in this tuple.
      If this entry is invalid, then copy this message into this entry to update. After this update, call the Validity Check function specified in this rule with this tuple as the actual parameter. If the check returns true, invoke the Processing Logic specified in this rule still with this tuple as the actual parameter. Publish the messages in the following way with the result returned from Processing Logic.
         When publishing a message, if this message is a consensus message, then each BFT-APP-Handler should publish this message together with the combined signatures and timestamps on this message.
         Otherwise, each BFT-APP-Handler adds its signature into the payload of published message, together with its timestamp, which is covered by the signature.
   If this message is not copied into any tuple in the last step, then create a new tuple and add it to the list. The entry corresponding the topic of this message in this new tuple is updated with this messages, and other entries in this new tuple are marked as invalid. A timer is setup for this tuple with the default timeout if no timeout value is specified in this rule. If a tuple is updated (as does in the last step), the timer is restarted.

Processing timeout event: when a timeout event happens for a tuple, then this tuple is removed from the list containing it.

### EXAMPLE

An example will now be presented to illustrate the disclosed method. In this example, the Topic Translation rules present in Table 1 are used to illustrate the working mechanism of the interpretation engine of each BFT-APP-Handler. One BFT-APP-Handler is taken in this example and all BFT-APP-Handlers work in the same way. In this example, four MQTT brokers and four BFT-APP-Handlers are considered.

At the beginning, all entries in Buffer Type 1 and Buffer Type 2 of a BFT-APP-Handler are initialized as invalid (or null) for all topics, and its Buffer Type 3 for all rules are empty lists. Initialized buffer of all types are illustrates in FIGS. 5-7. Only Smoke topic is considered in this example, and Temperature topic is omitted, for simplicity.

Assume that in system 200, publisher device 102 is a smoke detector. Publisher device 102 may publish a smoke message m to all MQTT brokers, each of which publishes this message to each BFT-APP-Handler. As such, each BFT-APP-Handler may receive a maximum of four copies of the original smoke message (one from each MQTT broker). In some examples, a BFT-APP-Handler may receive less than four copies of the smoke message as one of the MQTT broker may be faulty or compromised. In this situation, the faulty or compromised MQTT broker may publish a different message to the original smoke message or may not publish the smoke message.

Assume the abstract format of m corresponds to {topic: Smoke, payload: 1}. In this example, this message is not a BFT-APP-Handler origin message, as per Definition 1, as the message topic is an input topic to a rule in the set, but is not an output topic of any rule in the set. As this message is not a BFT-APP-Handler origin message, it may be put into Buffer Type 1.

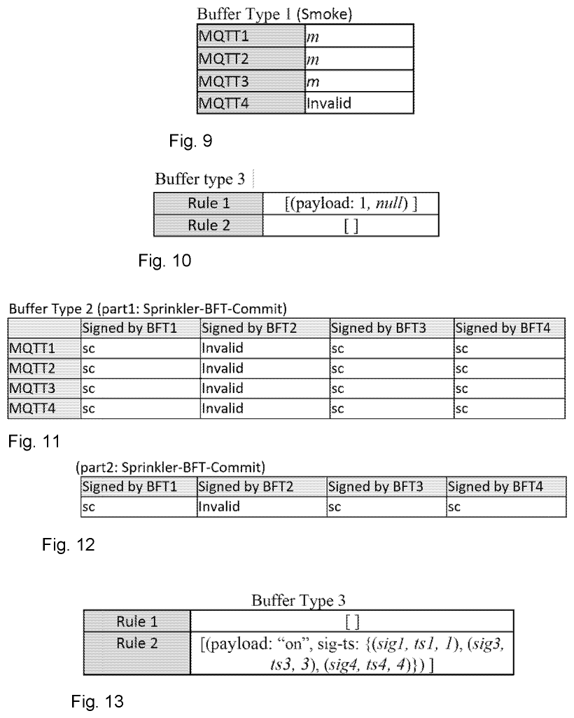

FIG. 9 illustrates a Buffer Type 1 for the Smoke topic where messages from the smoke sensor has been received, in the example. In FIG. 9, it can be seen that this BFT-APP-Handler has received the smoke message from three MQTT brokers. This BFT-APP-Handler has not received the smoke message from MQTT4, as the this message broker may be faulty or compromised.

Since three entries in the buffer shown in FIG. 9 contains the same message, a consensus is determine across the message brokers and the payload (the message value) of message m is moved to Buffer Type 3. In some examples, message m may be moved to Buffer Type 3 as soon as 2*f+1 copies of the message (3 copies in this example) are received by the respective handling module. As such, the fourth entry in FIG. 9 may be marked as invalid as a fourth copy of the smoke message was not necessary to form a consensus.

FIG. 10 illustrates a Buffer Type 3 after determining a consensus in the Buffer Type 1 in the example. As can been seen in FIG. 10, this Buffer Type 3 may have a new tuple, containing message value of ‘1’, but no temperature value as represented by null (the temperature is not considered in this example for simplicity). However, it is noted that if temperature is considered, a second Buffer Type 1 would be created on each BFT-APP-Handler corresponding to the ‘Temp’ topic and, upon receiving multiple copies of a temperature message via the multiple message brokers and determining a consensus across the multiple message brokers, the message value of the temperature message would be moved to this Buffer Type 3. As such, null would be replaced with the payload (the message value) of the temperature message. The order of messages in the tuple is consistent with the declared Input Topics in the corresponding Topic Translation rule. For example, as the input topics of rule 1 are presented as [(Smoke, s), (Temp, t)], the tuple in Buffer Type 3 are ordered accordingly.

After the tuple is added in the Buffer Type 3, the validity check function defined by the corresponding rule is applied to the tuple (1, null) and returns true as the smoke value is not null, in this example. Then, this tuple is processed by applying the corresponding processing logic function (decision function), which returns “on” as the smoke value is equal to 1. Then, the following message is published by each good BFT-APP-Handler with the signature that processes the message.

In an example, say this message is processed by the first BFT-APP-Handler. Let sig1 be the signature of the first BFT-APP-Handler. The processed message published by this BFT-APP-Handler may be {topic: Sprinkler-BFT-Commit, payload: “on”, sig-ts: (sig1, tm1, 1)}, where 1 is used as an identifier of this BFT-APP-Handler. tm1 may be the timestamp indicative of the time that the message is processed by the first BFT-APP-Handler or the time that the message is signed by the first BFT-APP-Handler.

Each BFT-APP-Handler may send this signed message to each message broker. Each message broker may then publish each signed message to each BFT-APP-Handler. As a result, each BFT-APP-Handler may receive a maximum of sixteen signed messages, four signed messages for each of the four BFT-APP-Handlers. As these signed message are received by each BFT-APP-Handler, each handler fills a Buffer Type 2 part 1 according to the message broker that the signed message is received from and the signature on the signed message (which indicated the origin of the signed message). However, as discussed previously, each BFT-APP-Handler may receive less than sixteen signed messages, depending on whether one of the multiple message brokers 110 or multiple handling modules 120 may be compromised. Receiving multiple copies of the signed message enables a consensus to be established, which enables a message to be processed and communicated despite the possibility of compromised nodes. This enables the IoT network to become attack and fault tolerant.

The Sprinkler-BFT-Commit message in the last step may be put into Buffer Type 2 on each BFT-APP-Handler. Note that in the Sprinkler-BFT-Commit messages received from different BFT-APP-Handlers, the payload should be the same for all BFT-APP-Handlers, but signatures and timestamps in the sig-ts part of the message may be different. As a result of processing the second part of Buffer Type 2, only the payload is checked whether there at least 2+f+1 same messages before moving the buffer contents to Buffer Type 3.

As an example, consider the situation where one of the BFT-APP-Handlers has become faulty (the BFT-APP-Handler may have also been maliciously attacked). In this example, consider that the second BFT-APP-Handler has become faulty. Assume the abstract format of sc corresponds to {topic: Sprinkler-BFT-Commit, payload: “on”}. After receiving the multiple signed messages from the multiple message brokers, the Buffer Type 2 part 1 on each good BFT-APP-Handler (i.e., each handler that is not the second BFT-APP-Handler) may resemble the buffer illustrated in FIG. 11. In FIG. 11, it can be seen that each entry in the second column, corresponding to the second BFT-APP-Handler, is invalid as this BFT-APP-Handler has become faulty.

In this example, as there are three or more copies of the message with the “Sprinkler-BFT-Commit” topic in the first, third and fourth column, a consensus can be determined in these columns across the message brokers, despite the second BFT-APP-Handlers being faulty. As such, the message is moved to the corresponding Buffer Type 2 part 2, which can be seen in FIG. 12. More specifically, for each column where a consensus is determined, the corresponding entry in the Buffer Type 2 part 2 is filled with the message. In other words, the BFT-APP-Handler has received enough signed messages from one of the BFT-APP-Handlers. As such, the first, third and fourth entries of the Buffer Type 2 part 2 are filled with sc as a consensus was determined in the corresponding columns of the Buffer Type 2 part 1.

In this example, as there are three copies of the message with the “Sprinkler-BFT-Commit” topic in the Buffer Type 2 part 2, a consensus can be determined across the multiple handling modules. As such, upon determining a consensus across the multiple handling modules, the buffer contents are moved to Buffer Type 3. As the topic of the Sprinkler-BFT-Commit message is the input topic of rule 2 in Table 1 (i.e., the consensus rule), the Sprinkler-BFT-Commit message may be moved in the second entry of the Buffer Type 3, which corresponds to rule 2.

FIG. 13 illustrates this Buffer Type 3 after determining a consensus in the Buffer Type 2 part 1 and after determining a consensus in the Buffer Type 2 part 2 in the example. Note that the signatures and timestamps from different BFT-APP-Handlers are combined as a result of moving to Buffer Type 3. However, the signatures and timestamps correspond to the BFT-APP-Handlers that participate in the consensus determined from Buffer Type 2. As such, the signature of the second BFT-APP-Handler does not appear.

With the update of Buffer Type 3 for Rule 2, this message is then processed by applying the one of the rules in the set. The consensus rule (i.e., rule 2 of Table 1) is determined as the rule to apply as here. As such, the consensus rule is applied by firstly applying the corresponding validity check function and then applying the processing logic function to the message value stored in Buffer Type 3. The validity check function (the true function) returns true and the processing logic function (the id function) is just an identity function and hence, returns the same message value. Hence, the following consensus message is generated: {topic: Sprinkler-BFT-consensus, payload: “on”, sig-ts: {(sig1, ts1), (sig3, ts3), (sig4, ts4)}}. This consensus message may then be published by each BFT-APP-Handler to each MQTT broker, where each MQTT broker may then publish the consensus message to subscriber device 103.

It is noted that both a message broker and a handling module may be compromised, however a consensus message may still be generated. In the example above where the second BFT-APP-Handler is compromised, any one of the message brokers may have also been compromised, however as the first, third and fourth columns of the Buffer Type 2 part 1 (as shown in FIG. 11) would still contain 2+f+1 copies of the message, a consensus can be established across the message brokers. As a result, a consensus can be established across the multiple handling modules (by using Buffer Type 2 part 2) and hence, a consensus message can be generated despite a message broker and a handling module being compromised. However, it is further noted that a consensus message may not be generated if two message brokers or two handling modules are compromised.

### Processing of Messages From BFT-APP-Handlers

Network components, such as subscriber device 103 (e.g., a sprinkler), that receive consensus messages from BFT-APP-Handlers may be configured with the public keys of BFT-APP-Handlers. As such, each network component may be configured to verify each signature on the consensus message using the public key of each handler module. In addition, network components such as subscriber device 103 may be configured to be subscribed to the output topic of the consensus rule, as defined in the set of rules. As such, as a result of subscribing to a topic, the network components may be configured to determine whether the messages of this topic are consensus messages:
If a consensus message is received by a network component, then 2*f+1 signatures of BFT-APP-Handlers may be verified and the corresponding timestamps are checked to prevent replaying signatures. Since the same consensus messages may come from multiple BFT-APP-Handlers, the receiver may buffer a new and fresh consensus message for an application-specific period of time and discarded the repeated messages.
If the messages of this topic are not consensus messages, these message may not be buffered by the network component, as a compromised BFT-APP-Handler may generate a surplus of such messages in a short period of time, and the processing or these messages are application specific.

### Access Control Configuration of Publish/Subscribe Service

The Publish/subscribe services like MQTT brokers may be configured to control the access of all network components to the services, in terms of topics they can subscribe and publish. For example, the MQTT brokers may:
Configure the access control list for the BFT-APP-Handlers, which may enable the BFT-APP-Handlers to subscribe only to topics declared in Input Topics or may enable BFT-APP-Handlers to only publish topics specified in Output Topics; and
Configure the access control list for sensors or other publishing clients, which may enable sensors (or publishing clients) to publish only pre-defined topics (“room1/pos1/temp”), so these sensors cannot impersonate other sensors.

### Security Analysis

The security of this attack/fault tolerance framework of the disclosed system and method is analysed with the following three cases. In each case, one type of network components is assumed compromised or faulty.

If a BFT-APP-Handler is compromised, it cannot generate BFT-APP-Handler origin messages or consensus messages by impersonating other BTT-APP-Handlers, because these messages have the signatures of each or all sending BTT-APP-Handlers. It may intend to impersonate other network components like sensors that do not have signatures in their messages; however, this attack may be prevented with access control imposed by MQTT Brokers, as discussed above.

If a MQTT broker is compromised, it cannot generate enough number of fake or tampered messages (e.g., “/room1/pos1/temp”) for fully-connected sensors to deceive BFT-APP-Handlers. In other words, it cannot generate enough number of fake or tampered messages to reach a consensus. For single connection sensors, a MQTT broker may produce fake messages or tamper with messages. In this disclosure, the tolerance for single connectivity may be achieved by using physical replicas of sensors, and the values of these sensors are processed with Process Logic in Topic Translation rules (e.g., temperatures are published by four sensors; if only one sensor publishes a temperature value, this value is not processed; if a temperature value is not in range, it is ignored in Process Logic programmed by users).

If a sensor (or other component publishing messages) is compromised, it may impersonate other sensors to publish data. In the disclosed system and method, each sensor has its own distinct publishing topics, so access control can be defined and enforced by MQTT brokers. Thus, it cannot impersonate other publishing clients.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

What is claimed:

1. A method for communicating a message on an Internet of Things (IoT) network comprising multiple handling modules, the method comprising:
performing by each of the multiple handling modules:
subscribing to messages from a publisher device;
receiving a message from the publisher device;
processing the message from the publisher device to generate a processed message;
signing the processed message using a private key stored on the handling module to generate a signed message;
sending the signed message to other handling modules of the multiple handling modules;
subscribing to messages from the other handling modules;
receiving multiple signed messages from the other handling modules, each of the multiple signed messages comprising multiple respective signatures;
determining a consensus upon receiving a majority number of the multiple signed messages from the other handling modules having corresponding payloads;
in response to determining the consensus, generating a consensus message containing the multiple respective signatures of the handling modules; and
sending the consensus message to a subscriber device,
wherein receiving and sending messages between the publisher device, the subscriber device and the other handling modules comprises sending and receiving messages to and from multiple message brokers.

2. The method of claim 1, wherein receiving and sending messages to and from the multiple message brokers comprises using a messaging protocol, the messaging protocol being one of:
Messaging Queue Telemetry Transport (MQTT) protocol;
Advanced Message Queuing Protocol (AMQP);
Constrained Application Protocol (CoAP); or
Data Distribution Service (DDS).

3. The method of claim 1, wherein processing the message comprises receiving multiple copies of the message from the multiple message brokers and storing each message in a one-dimensional data buffer at a data location within the buffer, wherein the data location is associated with one of the multiple message brokers.

4. The method of claim 1, wherein the method further comprises determining a set of rules, wherein
each message comprises a message topic; and
each rule in the set defines:
an input topic and an output topic; and
a processing logic function, wherein applying the processing logic function to an input value associated with the input topic determines an output value associated with the output topic.

5. The method of claim 4, wherein the output topic of a rule in the set is the input topic to another rule in the set.

6. The method of claim 4, wherein, performing by each one of the multiple handling modules, processing the message comprises:
determining a rule in the set to apply to the message by associating the message topic of the message with the input topic of one of the rules in the set;
wherein the input value associated with the input topic corresponds to a payload of the message;
applying the rule to the message by applying the respective processing logic function to the input value to determine the output value associated with the output topic, the processed message thereby comprising the output topic and the output value.

7. The method of claim 4, wherein the set of rules comprises a consensus rule and generating the consensus message comprises processing the message by applying the consensus rule;
wherein the output topic of the consensus rule is different from the input topic of any other rule in the set and the consensus message comprises the output topic of the consensus rule.

8. The method of claim 4, wherein each rule in the set defines a validity check function and processing the message or the signed message comprises validating the message by applying the validity check function to the message.

9. The method of claim 7, wherein, if the message topic of the signed message corresponds to the input topic of a rule in the set and the rule is different from the consensus rule, the method further comprises, performing by each one of the multiple handling modules:
processing the signed message by applying the rule to the signed message to generate an output message;
wherein applying the rule comprises applying the respective processing logic function to a payload of the signed message to determine an output value and the output message comprises the output value and the output topic of the rule.

10. The method of claim 9, wherein, performing by each one of the multiple handling modules, signing the processed message or the output message comprises adding a timestamp to the message, the timestamp being indicative of a time that the message is signed by the handling module.

11. The method of claim 9, wherein, upon receiving the multiple signed messages from the multiple message brokers, processing the signed message comprises storing each message in a two-dimensional data buffer at a data location within the buffer, wherein
a first dimension is indicative of the multiple message brokers and a second dimension is indicative of the multiple handling modules; and
the data location is associated with one of the multiple message brokers and one of the multiple handling modules.

12. The method of claim 11, wherein, upon receiving messages from the multiple message brokers, storing the messages in the one-dimensional or two-dimensional data buffer comprises filling the one-dimensional or two-dimensional data buffer asynchronously by storing each message at the respective data location within the one-dimensional or two-dimensional data buffer.

13. The method of claim 11, wherein determining the consensus among the multiple signed messages comprises determining a consensus across the multiple message brokers and then determining a consensus across the multiple handling modules from the two-dimensional data buffer.

14. The method of claim 13, wherein each of the multiple respective signatures in the consensus message corresponds to the signature of each handling module that participates in the consensus across the multiple handling modules.

15. The method of claim 1, wherein the method further comprises, performing by each one of the multiple handling modules, verifying each signed message received from the other handling modules using a public key of each other handling module and discarding the signed message if the signature does not correspond to the other handling module.

16. (canceled)

17. A computer system comprising:
a publisher device;
a subscriber device;
multiple message brokers, each configured to
subscribe to messages from the publisher device and messages from multiple handling modules; and
publish messages to the multiple handling modules and the subscriber device; and
multiple handling modules, each configured to:
subscribe to messages from the publisher device;
receive a message from the publisher device;
process the message from the publisher device to generate a processed message;
sign the processed message using a private key stored on the handling module to generate a signed message;
send the signed message to the other handling modules;
subscribe to messages from the other handling modules;
receive multiple signed messages from other handling modules of the multiple handling modules, each of the multiple signed messages comprising multiple respective signatures;
determine a consensus upon receiving a majority number of the multiple signed messages from the other handling modules having corresponding payloads;
generate a consensus message containing the multiple respective signatures of the handling modules in response to determining the consensus; and
send the consensus message to the subscriber device.

18-19. (canceled)

20. The computer system of claim 17, wherein each handling module comprises a first memory configured to store each message received from the multiple message brokers in a one-dimensional data buffer at a data location within the buffer, wherein the data location is associated with one of the multiple message brokers.

21. The computer system of claim 17, wherein each handling module comprises a second memory configured to store each message received from the multiple message brokers in a two-dimensional data buffer at a data location within the buffer, wherein
a first dimension is indicative of the multiple message brokers and a second dimension is indicative of the multiple handling modules; and
the data location is associated with one of the multiple message brokers and one of the multiple handling modules.

22. The computer system of claim 17, wherein the subscriber device is configured to verify each signature on the consensus message using a public key of each handler module.
